(19) United States
(12) Patent Application Publication
(10) Pub. No.: US 2010/0126610 A1
(43) Pub. Date: May 27, 2010

(54) GAS AND WATER LEAK DETECTING SYSTEM WITH HUMAN PRESENCE DETECTOR

(76) Inventor: Paolo Diprima, Caltanissetta (IT)

Correspondence Address: BIRCH STEWART KOLASCH & BIRCH, PO BOX 747, FALLS CHURCH, VA, 22040-0747, US

(21) Appl. No.: 12/596,625

(22) PCT Filed: Apr. 15, 2008
(86) PCT No.: PCT/IT08/00250

§ 371 Date: Oct. 19, 2009

(30) Foreign Application Priority Data
Apr. 20, 2007 (IT) CI.2007A000030

(51) Int. Cl. F16K 31/48

(52) U.S. Cl. 137/624.11

(57) ABSTRACT

System security and control, also at distance through GSM module, of water supply, liquids and gas supply (of urban facilities for civil houses, cylinder, fixed gas cylinder) by opening and/or closing multiple automatic electromechanical valves. The management system is based on an electronic control divided into gas/section and liquid section and a series of sensors, as presence detectors, detectors of gas and liquids, located in the most appropriate place and at the discretion of the user. As Regards as the valves related to gas section, these valves should be installed outside the house or working place to prevent that the escape of gas that could happen in the section of pipe located before the electronic valve, may spread inside the environment that is monitored, thus thwarting, in this way the installation and use of the system itself. Also for the water/liquid section, for the positioning of the electronic valve, we use the same principles made for the gas section. In any case for both gas/liquid sections it is advisable to install the valves outside the environment that we want to preserve in order to obtain the maximum security; but, of course, the user can install the valves where it seems appropriate for him/her and beneficial to the own needs. The user can control the various functions of the system through the central unit that is programmable with buttons START/STOP that are inside the environment, or check the status of the system at a distance by a GSM module integrated within the central unit which can send messages of signals or alarm and receive instructions command and/or control.

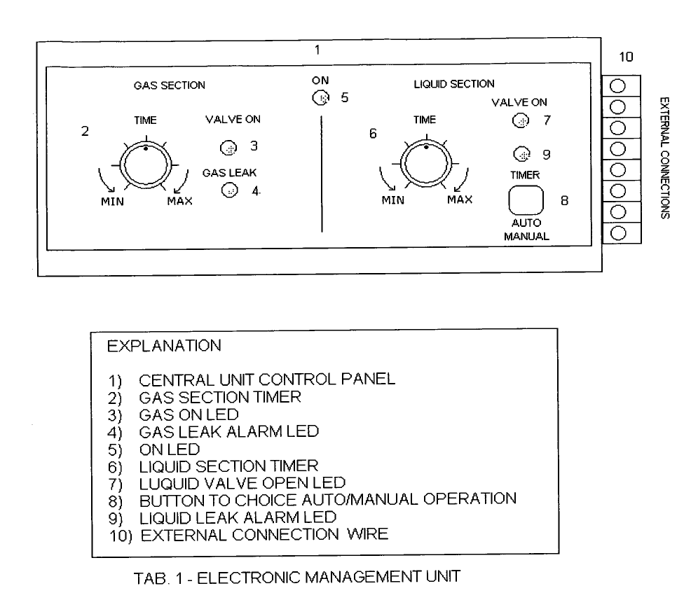

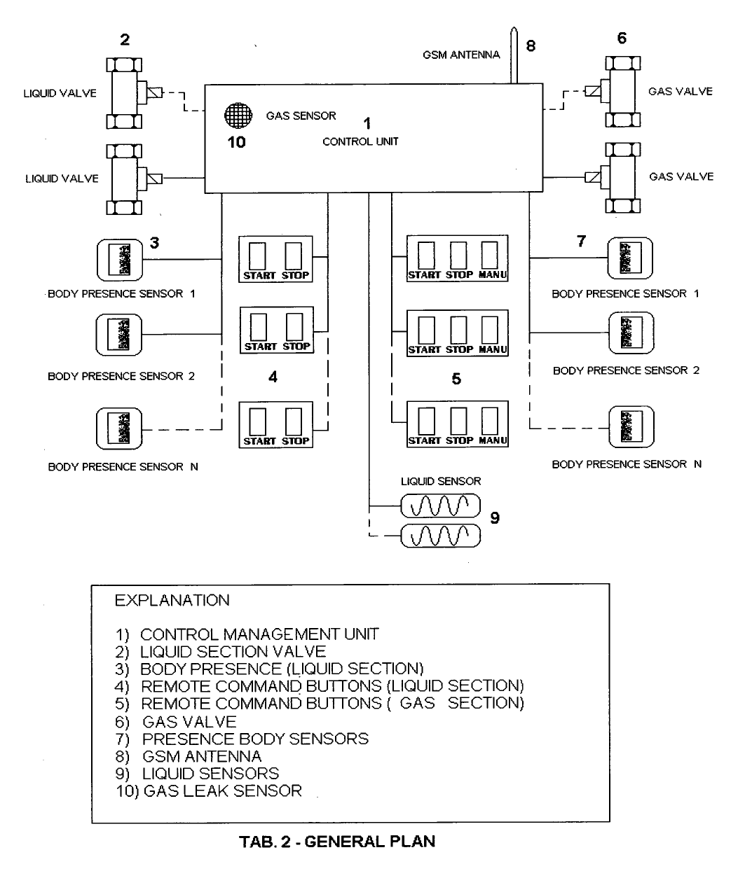

System security and control, also at distance through GSM module, of water supply, liquids and gas supply (of urban facilities for civil houses, cylinder, fixed gas cylinder) by opening and/or closing multiple automatic electromechanical valves.

The management system is based on an electronic control divided into gas/section and liquid section and a series of sensors, as presence detectors, detectors of gas and liquids, located in the most appropriate place and at the discretion of the user.

As Regards as the valves related to gas section, these valves should be installed outside the house or working place to prevent that the escape of gas that could happen in the section of pipe located before the electronic valve, may spread inside the environment that is monitored, thus thwarting, in this way the installation and use of the system itself.

Also for the water/liquid section, for the positioning of the electronic valve, we use the same principles made for the gas section.

In any case for both gas/liquid sections it is advisable to install the valves outside the environment that we want to preserve in order to obtain the maximum security; but, of course, the user can install the valves where it seems appropriate for him/her and beneficial to the own needs.

The user can control the various functions of the system through the central unit that is programmable with buttons START/STOP that are inside the environment, or check the status of the system at a distance by a GSM module integrated within the central unit which can send messages of signals or alarm and receive instructions command and/or control.

### The Bases of the Technique

The principle of working of the invention is based on the possibility of closing (and therefore stopping) the flow of the liquid and/or of inflammable gas automatically after a certain time.

The period of opening of the electric valves is programmable by the user who may also close them at any time and immediately through STOP buttons. In the case of loss of gas or water leak, these events are detected by special sensors (supplied to the system), and the valves will be closed immediately.

The emergency intervention will be indicated through alarms and lights produced by the electronic central unit and also through calls or SMS messages—the GSM module.

When the presence of people is not detected in the environment—by special infrared sensors and/or micro-waves—, after a certain period of time, predetermined by the user, the valves are closed. The automated equipment that are normally available on the market are based only on detection of the presence of flammable gases, potentially dangerous, in environments such as kitchens and bathrooms or where there are burners or gas stoves, and they are involved only when the saturation of gas becomes very dangerous. These considerations are also extensible to the control of non-dangerous liquids, such as water, but that nevertheless represents, especially in the condominium, the main cause of damage to structures and ceiling-roofing (see flooding and infiltration).

### THE OBJECTIVE THAT THE INNOVATION INTENDS TO REACH

As said before, the purpose that the systems aims to reach is to prevent that in any house, craft or industrial environment, there may be dangerous gas leaks (with consequent danger of fire), or very harmful flooding. The control system is, in fact, based on electronic timers divided into two distinct sections, working independently of one another; one section sets and manages the opening and closing of electro valves in the gas section, while the other section sets and manages the opening and closure of the electromagnetic-valve section related to water/liquid, with independent times and way of programming.

Since opening times of the system are determined by the user, the system can also avoid the burning of food cooking forgotten on the stove (because the person involved in that activity is out of the room or sleepy): This forgetfulness may become very dangerous and harmful and cause fires. The same considerations are for the liquid section, because if the user forgets a tap open or there is a rupture or leak in the water system, the valves will close immediately it because of the detection by sensors of the presence of water on floor (or on the point chosen by the user). These abnormal events will be notified after a call GSM module to the number or phone number specified, or by sending an SMS, in addition to optical and acoustic alerts placed on the central unit.

### Analysis of the Achieved Results.

### Detailed Description of the Gas Section.

The management system is based, as already mentioned, on the control of the safety valve of Gas installed outside the environment; this control is effected by a timer programmable by the user (through a special command placed on the control unit system, with set times ranging from a few minutes to several hours) and one or more sensors that detect the presence of the movement of people within the environment which you want to control. If the sensor does not detect any presence in the environment (which in this case is considered not controlled), after the programmed time, the valve will be closed automatically after the predetermined time; in other words, if in the house there is not any person, the system automatically closes the valve. But before closing the valve, the central unit beeps, in a way easily recognizable, for a predetermined time, thus alerting people that are not in the monitored environment, but staying near or inside the house, that the system will close the valve.

In this way the user can restore the normal functioning—and avoid the closure of the electro valve, simply when he is detected by the presence sensor. In this case, the timer will be reinitialized again. This is considered normal operation; in any case, the electronic central-system is able to detect any leaks or spills and gas fumes (through a sensor put within the unit or at a remote location) when the concentration exceeds the limit (and it is judged dangerous) the valve will be closed immediately and in no way you can resume the delivery, nor through the start button, until the concentration of gases or fumes come back to normal levels.

This security procedure is managed by the central unit.

The electro valves are controlled by buttons for opening and closing that are installed inside the environment and placed in a position established by the user and/or remote location compared to the central unit system. In particular, the button, called START, opens valves and starts the cycle timing and monitoring described above, while the STOP button has a function to close the electro valves at any time and at any stage of operation of the central unit; all this is then considered as a command emergency and/or safety. Through these two buttons the user has the complete and immediate control of the electromechanical valves.

### Details of the Water/Liquid Section:

The control system of the liquid section is made by electronic central unit and has an operation very similar to that of gas section but it is totally independent as regards the commands, time, sensors and valves. Here, too, there is a timer, with set time from a few minutes to several hours, there is the sensor or presence sensors (placed where you like in the rooms and functionally distinct from those of the gas section); there is the START button to start the opening of the electro valves (They may be more than one to close distinct water systems for water supply; they may be independent one another). The STOP button is used to close immediately the valves that we want to be closed. They are totally independent from the gas section. It is possible to install control sensors of liquids (such as humidity sensors, water detectors that detect the presence of water on the floor, or on other surfaces, or floating) in order to prevent and avoid flooding or leakage of liquids from containers that contain them. In a manner very similar to gas section these sensors-once-activated determine the immediate closure of its cut-off valves.

This section, unlike the one on the gas, allows a manual management for the opening and closing of valves, using a specific button, known as AUTO/MANUAL placed in the central unit and installed remotely through a button (located in a comfortable position). Through this button you can exclude the timer and thus avoid the automatic closure of the valve that in this way will be handled only by the buttons Start (opening) and Stop (Close). Of course the leakage detected by special sensors will cause the immediate closure of the electro valves, since this function of this monitoring can not be excluded.

As Regards as the automatic mode of operation of the cycle, it will start by the START button, it will open the electro valve opens as well as the timer. If the sensor or sensors section related to liquid water section do-not detect any presence after the set time, the electromagnetic-valve is automatically closed. But before doing so, the central unit beeps, in a way easily recognizable, for a predetermined time, thus alerting people that are not in the near environment, but staying near or inside the house, of the imminent closure of valves.

In this way the user can restore the normal functioning—and avoid the closing of valves—simply because he is detected by the presence sensor.

Vice versa, if the sensor detects movements within the monitored environment, the timer is constantly being blocked in such a way that, if there is the constant presence of people in movement, the cycle will never end and the valve will always remain open.

Places of application of the system:

### Houses, Business, Community Associations, Resorts and Caravans.

### Method of Application

The system was designed to prevent fire: for example, if a person puts the pot on the stove and forgets it on the same stove, for a variety of reasons, through this system he/she will avoid dangerous overheating and combustion, because the central unit will close the electro valve automatically, after a predetermined time.

In the case of a gas leak from a pipe or a cooker etcetera, or fumes in general, the closing of valves will be automatically through the detective sensor that is integrated into the security system.

Since the system manages the status of a electro valve it is not important to see the kind of implant and for this reason, the system can also be adapted to the fixed gas cylinders or propane gas and butane, or to new gas methane released by the network. The system can also be installed and/or integrated into vehicles as campers and caravan.

As regards as the water section, through this system of control and management it is possible to avoid any flooding. For example, if a person leaves a tap open, a tap of running water, or from containers or tanks,) or if there was the rupture of a tube or a connection, the electronic control will ensure the closure of the system, through detective sensors, and in any case the automatic closing of it immediately, thus limiting the damage caused and/or suffered.

### Analysis of the Achieved Results

FINALLY this system allows management to obtain a number of benefits with regard to security and the prevention of accidental events, such as fires and flooding, but also represents a remarkable improvement of living and working conditions, providing control operation and, therefore, security that has not easily found till now.

1-13. (canceled)

14. A control system for liquid and/or gas supply lines in civil or industrial premises, comprising:
at least one electrovalve configured to be inserted in the supply line for the interruption of the liquid and/or gas flow towards a premises;
sensor means configured to detect the presence of a person inside said premises for the generation of a first control signal in absence of persons therein;
an electronic control unit configured to receive said first control signal and to generate a closing electrical signal for automatically closing said at least one electrovalve;
a programmable electronic timer connected to said sensor means to enable the forwarding of said control signal towards said control unit after a predetermined time during which said sensor means do not detect the presence of persons;
wherein said control unit has at least one hand operating member which interacts with said programmable timer to disable this latter.

15. A control system as claimed in claim 14, wherein said control unit comprises an electronic control panel connected to said sensor means.

16. A control system as claimed in claim 15, wherein said hand operating member is coupled to said electronic control panel.

17. A control system as claimed in claim 16, wherein said sensor means comprise at least one presence sensor coupled to said control unit.

18. A control system as claimed in claim 17, wherein said sensor means further comprise at least one fluid presence detector configured to detect the presence of a predetermined minimum concentration of liquid and/or gas inside of the premises.

19. A control system as claimed in claim 18, wherein said fluid detector is configured to generate a second control signal to be forwarded toward said control unit for the generation of said closing signal of said electrovalve.

20. A control system as claimed in claim 14, comprising actuating means of said electrovalve for the selectively opening/closing thereof by an user.

21. A control system as claimed in claim 20, wherein said actuating means comprise an hand operated closing button for closing said electrovalve.

22. A control system as claimed in claim 21, wherein said actuating means comprise an hand operated opening button for opening said electrovalve.

23. A control system as claimed in claim 20, wherein said actuating means comprise a GSM module for receiving a remote actuating signal for the opening/closing of said electrovalve.

24. A control system for liquid and/or gas supply lines in civil or industrial premises, comprising:
at least one electrovalve configured to be inserted in the supply line for the interruption of the liquid and/or gas flow towards a premises;
sensor means configured to detect the presence of a person inside said premises for the generation of a first control signal in absence of persons therein;
an electronic control unit configured to receive said first control signal and to generate a closing electrical signal for automatically closing said at least one electrovalve;
a programmable electronic timer connected to said sensor means to enable the forwarding of said control signal towards said control unit after a predetermined time during which said sensor means do not detect the presence of persons;
wherein said control unit has at least one hand operating member which interacts with said programmable timer to disable this latter;
wherein said control unit comprises an electronic control panel connected to said sensor means;
wherein said electronic control panel comprises acoustic and/or light alarms for signalling the closing of said electrovalve.

25. A control system for liquid and/or gas supply lines in civil or industrial premises, comprising:
at least one electrovalve configured to be inserted in the supply line for the interruption of the liquid and/or gas flow towards a premises;
sensor means configured to detect the presence of a person inside said premises for the generation of a first control signal in absence of persons therein;
an electronic control unit configured to receive said first control signal and to generate a closing electrical signal for automatically closing said at least one electrovalve;
a programmable electronic timer connected to said sensor means to enable the forwarding of said control signal towards said control unit after a predetermined time during which said sensor means do not detect the presence of persons;
wherein said control unit has at least one hand operating member which interacts with said programmable timer to disable this latter;
wherein said control unit comprises an electronic control panel connected to said sensor means;
wherein said electronic control panel comprises a first section for managing and controlling a gas supply line gas and a second section for managing and controlling a liquids supply line.

26. A control system as claimed in claim 25, wherein at least one of said sections of said electronic control panel has a respective programmable timer connected to an hand operating member, each of said sections having at least one respective electrovalve and respective actuating means of said at least one electrovalve.
